(19) United States
(12) Patent Application Publication
(10) Pub. No.: US 2014/0293274 A1
(43) Pub. Date: Oct. 2, 2014

(54) WAVEFRONT MEASURING SYSTEM WITH LARGE DYNAMIC MEASURING RANGE AND MEASURING METHOD

(71) Applicant: HON HAI PRECISION INDUSTRY CO., LTD., New Taipei (TW)

(72) Inventor: LI-YING WANG HE, Tu-Cheng (TW)

(73) Assignee: HON HAI PRECISION INDUSTRY CO., LTD., New Taipei (TW)

(21) Appl. No.: 13/974,024

(22) Filed: Aug. 22, 2013

(30) Foreign Application Priority Data
Apr. 2, 2013 (TW) 102111846

(51) Int. Cl. G01J 9/00

(52) U.S. Cl. CPC G01J 9/00
USPC 356/121

(57) ABSTRACT

A wavefront measuring system with large dynamic measuring range includes a measuring unit, a control unit, and a processing unit. The measuring unit includes a wavefront dividing component, a focusing component and a photosensor. The wavefront dividing component samples a part of a laser beam (a sampled light beam) in a measuring plane, the focusing component focuses the sampled light beam on a photosensitive surface of the photosensor to form a light spot, the photosensor detects the presence of the light spot, the data processing unit acquires the locational information of the light spot and calculates the direction of the sampled light beam beam. The control unit drives the measuring unit to a different position in the same measuring plane, the wavefront dividing component samples another sampled light beam. The data processing unit calculates the wavefront distribution on the measuring plane based on the direction determined sampled light beams.

### BACKGROUND

1. Technical Field

Embodiments of the present disclosure relate to laser wavefront measuring systems, and particularly to a laser wavefront measuring system with a large dynamic measuring range.

2. Description of Related Art

The Shack-Hartmann technique is commonly used for determining wavefront shape or error in a planar wavefront. The Shack-Hartmann wavefront sensor is a slope measurement device typically including a lenslet array, a two-dimensional detector array, acquisition hardware, and analysis software. Each lenslet in the array receives light from a portion of an incident wavefront. Light from the lenslet is focused within a “virtual” subaperture of the detector array, the detector subaperture generally being defined by those pixels located within a projection of the lenslet onto the detector array. The location or tilt of the focused light from a particular lenslet within each of these detector subapertures is used to determine the nominal slope of that portion of the incident wavefront. By calculating the slope of the incident wavefront from each light spot displacement at each of the lenslets, the shape of the wavefront can be determined. The dynamic range of a Shack-Hartmann wavefront sensor is typically subject to and restricted by the focal length of the lenslets and the dimensions of the detector subaperture (measured in units of pixel numbers) for each lenslet. In many systems, the combination of lenslet focal length and detector subaperture dimensions limits the maximum wavefront slope that can be measured. A need exists, therefore, for providing a wavefront measuring system with a larger dynamic measuring range.

### BRIEF DESCRIPTION OF THE DRAWINGS

FIG. 1 is a schematic block diagram of a wavefront measuring system according to one embodiment of the present invention, showing essential optical paths thereof.

FIG. 2 is a flowchart of one embodiment of a wavefront measuring method implemented by the wavefront measuring system of FIG. 1.

### DETAILED DESCRIPTION

The disclosure, including the accompanying drawings in which like reference numerals indicate similar elements, is illustrated by way of example and not by way of limitation. It should be noted that references to “an” or “one” embodiment in this disclosure are not necessarily to the same embodiment, and such references can mean “at least one.”

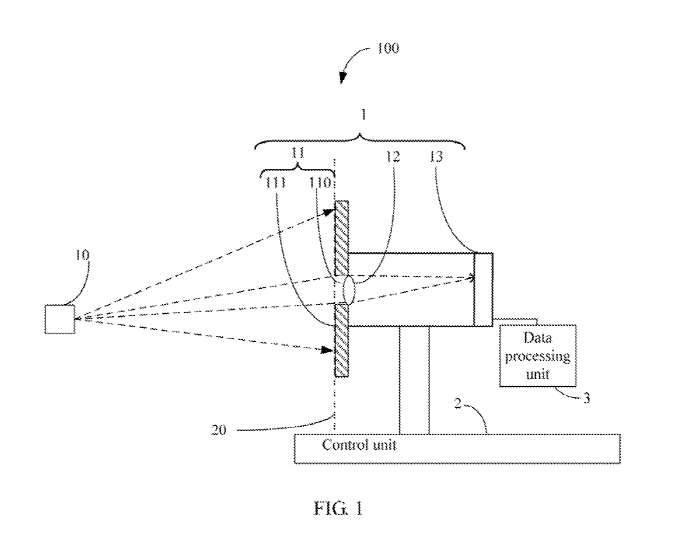

Referring to FIG. 1, a wavefront measuring system 100 includes a measuring unit 1, a control unit 2, and a data processing unit 3. The measuring unit 1 includes a wavefront dividing component 11, a focusing component 12, and a photosensor 13. The wavefront dividing component 11 is used for dividing an incident wavefront of a laser beam from a laser source 10 into a number of sampled light beams. The focusing component 12 is used for focusing each of the sampled light beams to a photosensitive surface of the photosensor 13, one at a time. The photosensor 13 and the focusing component 12 can be arranged in such a way that the photosensitive surface of the photosensor 13 is in the same plane with the focal plane of the focusing component 12. As a result, a light spot is formed on the photosensitive surface of the photosensor 13 when the sampled light beam passes through the focusing component 12.

The photosensor 13 detects the presence of the light spot on the photosensitive surface. The wavefront dividing component 11, the focusing component 12, and the photosensor 13 are integrated together into the measuring unit 1. That is, the measuring unit 1 is a single, unitary apparatus or piece of equipment. The control unit 2 drives the measuring unit 1 to move in the measuring plane 20, so that the measuring unit 1 detects different sampled light beams of different positions in the measuring plane 20. The data processing unit 3 determines the direction of each sampled light beam by the locational information of the light spot of the sampled light beam.

In the embodiment, the wavefront dividing component 11 is a light barrier 111 with a single micro-aperture 110. The diameter of the micro-aperture 110 is substantially less than the diameter of the laser beam. When the laser beam irradiates the light barrier 111, a part of the light beam which runs through the micro-aperture 110 forms a sampled light beam. The focusing component 12 is typically a micro-lens. The photosensor 13 is typically a charge coupled device (CCD) sensor or a complementary metal-oxide semiconductor (CMOS) sensor. The control unit 2 is typically a high precision stepper motor. The date processing unit 3 is typically a computer with data processing software.

The micro-aperture 110 is defined in the middle of the light barrier 111, and the focusing component 12 is fixed in the micro-aperture 110. The photosensor 13 is fixed behind the light barrier 111. When measuring, the micro-aperture 110 samples a light beam from an incident wavefront of a laser beam from a laser source 10. The sampled light beam passes through the focusing component 12, thereby forming a light spot on the photosensitive surface of the photosensor 13. The photosensor 13 detects the presence of the light spot. The data processing unit 3 acquires the locational information of the light spot, calculates the barycentric coordinate of the light spot based on the locational information, and further calculates the direction of the sampled light beam. After one sampled light beam has been measured, the control unit 2 drives the measuring unit 1 to another position in the same measuring plane 20, and measures another sampled light beam in the same manner. Finally, the processing unit 3 calculates the wavefront distribution of the whole laser beam on the measuring plane 20 through a wavefront reconstruction algorithm based on a number of direction determined sampled light beams.

The wavefront measuring system 100 with a large dynamic measuring range replaces a conventional lenslet array with the single micro-aperture 110. The single micro-aperture 110 can be moved freely in the measuring plane 20. Therefore, compared to a conventional wavefront measuring system, the dynamic measuring range of the wavefront measuring system 100 is effectively extended.

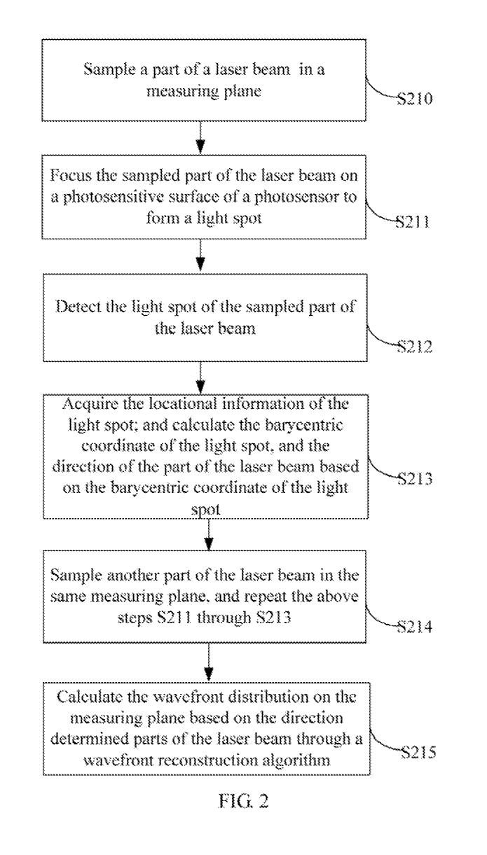

Referring to FIG. 2, a flowchart of one embodiment of a wavefront measuring method implemented by the wavefront measuring system of FIG. 1 is shown.

In step S210, the wavefront dividing component 11 of the measuring unit 1 samples a part of a laser beam from the laser source 10 in the measuring plane 20. The sampled part of the laser beam is hereinafter called “sampled light beam.” In detail, the wavefront dividing component 11 divides the sampled light beam from a wavefront of the laser beam at the wavefront dividing component 11.

In step S211, the focusing component 12 of the measuring unit 1 focuses the sampled light beam to form a light spot on the photosensitive surface of the photosensor 13.

In step S212, the photosensor 13 detects the presence of the light spot on the photosensitive surface.

In step S213, the processing unit 3 acquires the locational information of the light spot on the photosensitive surface, and calculates the direction of the sampled light beam based on the acquired locational information of the light spot. In detail, the processing unit 3 calculates the barycentric coordinate of the light spot, and calculates the direction of the sampled light beam based on the barycentric coordinate of the light spot.

In step S214, the control unit 2 drives the measuring unit 1 to another position in the same measuring plane 20, and controls repeating of steps S210-S213. In detail, such repeating begins with sampling another part of the laser beam from a wavefront of the laser beam at the wavefront dividing component 11.

In step S215, the processing unit 3 calculates the distribution of the wavefront of the laser beam on the measuring plane 20 based on the direction determined sampled light beams through a wavefront reconstruction algorithm.

Although certain embodiments have been specifically described, the present disclosure is not to be construed as being limited thereto. Various changes or modifications may be made to the present embodiments without departing from the scope and spirit of the present disclosure.

What is claimed is:

1. A wavefront measuring system comprising:
a measuring unit comprising:
a wavefront dividing component configured to sample a part of a laser beam in a measuring plane, the sampled part of the laser beam defining a sampled light beam;
a focusing component; and
a photosensor comprising a photosensitive surface;
wherein the focusing component is configured to focus the sampled light beam to form a light spot on the photosensitive surface of the photosensor; and
the photosensor is configured to detect a presence of the light spot;
a control unit configured to control the measuring unit to move in the measuring plane to detect different sampled light beams; and
a data processing unit configured to acquire locational information of the light spots of the different sampled light beams and calculate a wavefront distribution on the measuring plane of the laser beam based on the locational information of the light spots.

2. The wavefront measuring system of claim 1, wherein the wavefront dividing component, the focusing component and the photosensor are integrated together to form a single, unitary apparatus.

3. The wavefront measuring system of claim 1, wherein the wavefront dividing component comprises a light barrier with a single micro-aperture for sampling a sampled light beam from the laser beam, and a diameter of the micro-aperture is substantially less than a diameter of the laser beam.

4. The wavefront measuring system of claim 3, wherein the focusing component comprises a micro-lens configured to focus the sampled light beam from the micro-aperture to the photosensitive surface of the photosensor.

5. The wavefront measuring system of claim 1, wherein the photosensor is one of a charge coupled device (CCD) sensor and a complementary metal-oxide semiconductor (CMOS) sensor.

6. The wavefront measuring system of claim 1, wherein the control unit is a high precision stepper motor.

7. The wavefront measuring system of claim 1, wherein the data processing unit is a computer with data processing software.

8. The wavefront measuring system of claim 1, wherein the processing unit calculates a barycentric coordinate of each of the light spots based on the locational information of each of the light spots and further calculates a direction of each of the sampled light beams.

9. The wavefront measuring system of claim 8, wherein the processing unit calculates the wavefront distribution on the measuring plane of a laser beam through wavefront reconstruction algorithm based on the direction determined sampled light beams.

10. A wavefront measuring method with a large dynamic range, the wavefront measuring method comprising:
Sampling a part of a laser beam in a measuring plane, the sampled part of the laser beam defining a sampled light beam;
focusing the sampled light beam to form a light spot on a photosensitive surface of a photosensor;
detecting a presence of the light spot of the sampled light beam;
acquiring locational information of the light spot; and calculating a barycentric coordinate of the light spot, and a direction of the sampled light beam based on the barycentric coordinate;
repeating the above steps; and calculating the wavefront distribution on the measuring plane based on the direction determined sampled light beams.
